(19) United States
(12) Patent Application Publication
(10) Pub. No.: US 2006/0278496 A1
(43) Pub. Date: Dec. 14, 2006

(54) Method and device for retrofitting coin-operated vending devices for coin and non-coin operation

(76) Inventor: Frank J. Perry, Harrisburg, PA (US)

Correspondence Address: Jeffrey S. Habib, Esq.;Hooker & Habib, P.C., Suite 304, 100 Chestnut St., Harrisburg, PA, 17101, US

(21) Appl. No.: 11/152,296

(22) Filed: Jun. 14, 2005

(51) Int. Cl. G07F 9/10

(52) U.S. Cl. 194/350

(57) ABSTRACT

A method of retrofitting a coin-operated vending device having a power supply includes mounting a housing on the outside of the device that contains a note acceptor for non-coin payment and energizing the note acceptor with the power supply. The retrofitted device can be operated by coin or by non-coin payment.

### FIELD OF THE INVENTION

The invention relates generally to a method of retrofitting a coin-operated vending device for both coin and non-coin operation, a retrofit kit for retrofitting a coin-operated vending device, and a vending device retrofitted in accordance with the method.

### BACKGROUND OF THE INVENTION

Many vending devices in use today accept only coins for payment. For example, many of the tire inflators, vehicle vacuums, and car washing devices found at service stations, car washes, convenience stores, and various other locations take only 25-cent (quarter) coins. If prospective customers have insufficient change or the wrong change to use the device, they must obtain correct change from a change machine or attendant. Change machines and attendants are not available at many installations because of the installation's remoteness or low sales volume.

Often customers who might otherwise use a coin-operated vending device choose not to do so because of the inconvenience in having to handle or obtain change. It would be desirable from the point of view of both the customer and the device operator that the device offer the option to accept paper bills or other non-cash payment in addition to coins.

Many coin-operated vending devices accept only a single denomination coin, making it difficult to raise prices to offset increased costs. For example, a device that accepts only quarters (a preferred denomination for many vending devices) can have prices raised in only 25-cent increments. Reasonable price increases must be delayed because of the inflexible, fixed price points.

Furthermore, it can be counter-productive to raise prices charged for using coin-operated vending devices. Increased prices require more coins, further increasing consumer inconvenience.

Newer vending devices have integrated designs that include both coin acceptors for coin payment and non-coin acceptors for non-coin payment. Newly-installed soft-drink vending devices have both a coin acceptor and a dollar-bill acceptor that enables payment by coin or by dollar bill. Customer use and customer satisfaction both increase.

Some manufacturers propose replacing coin-operated vending devices with newer models having integrated designs that accept coin and non-coin payment. But the existing coin-operated vending devices have substantial useful lives remaining. It is not cost-effective to replace all the coin-operated vending devices with the newer models. And many existing devices cannot be converted in the field to accept coin and non-coin payment because there is insufficient room or insufficient security to add the additional hardware required for the conversion.

Thus there is a need to be able to retrofit existing coin-operated vending devices, such as tire inflators, vehicle vacuums, car washing devices and the like, with a note acceptor that enables device operation by coin or non-coin payment. The retrofitted vending device would be used by more customers, would increase customer satisfaction, would increase pricing flexibility, and would generate increased revenues to operators, while increasing the useful life of the devices.

### SUMMARY OF THE INVENTION

The invention is a method of retrofitting existing coin-operated vending devices with a note acceptor that enables additional operation of the device by non-coin payment, a retrofit kit for carrying out the method, and a vending device retrofitted in accordance with the method.

A conventional coin-operated vending device includes a coin acceptor housed in an outer casing and energized by the device's power supply. The coin acceptor generates a first control signal in response to valid input, and a first controller receives the signal to control operation of a device load to vend a good or service.

A method of retrofitting the coin-operated vending device in accordance with the present invention includes mounting a housing on an outer casing on the outside of the device. A note acceptor is installed in the housing. The note acceptor receives paper money (bills), credit cards, debit cards, tickets, or some other non-coin method of payment. The note acceptor is energized by the power supply and generates a second control signal in response to a valid input. The second control signal also controls the device load, either independently of the first control signal or in cooperation with the first control signal.

In one form of preferred embodiments of the method a second controller is mounted in the housing and operatively connected to the load. The second control signal is sent to the second controller. The first and second controllers are operatively connected in parallel with the load whereby each controller is capable of independently controlling the load to vend the good or service. The price point associated with each control signal can be independently set for vending a good or service at one price for coin payment and a second price, not necessarily the same as the first price, for non-coin payment.

In another form of preferred embodiments of the method the second controller is capable of receiving and responding to multiple control signals. Both the first and second control signals are sent to the second controller; the first controller is not used after the retrofit. Independent price points for coin and non-coin payment can be set as previously described. Alternatively, the second controller can be set to vend at a single price point with payment by any combination of coin and non-coin payment.

The first controller of some coin-operated vending devices are also capable of receiving and responding to multiple control signals. Embodiments of the method with such first controllers can include sending the second control signal to the first controller. The second controller is eliminated. Independent price points for coin and non-coin payment can be set or the first controller can be set to vend at a single price point with payment by any combination of coin and non-coin payment.

A kit for retrofitting a coin-operating device in accordance with the present invention includes a note acceptor, a housing for housing the note acceptor, and a second controller (if used). The housing is preferably configured for mounting on a flat outer surface of the device and includes an opening for receiving an electrical connection connecting the note acceptor to the power supply and optionally connecting the coin acceptor to the second controller.

The kit can also include a spacer that has one end or face configured to conform to a non-flat outer surface of the housing and the other end or face configured to mount the housing.

Some coin-operated vending devices or services vend multiple goods or distinct multiple services. Such devices include two or more coin acceptors that independently vend each good or service. A multiple-vend device can be retrofitted with a separate kit for each vend. Alternatively the housing can be configured to hold multiple note acceptors and, if used, multiple controllers, each note acceptor and controller associated with a respective vend.

In yet other embodiments the kit can include two or more note acceptors, each note acceptor configured for a different type of non-coin payment. For example, the kit can be provided with a bill acceptor and a credit card reader. The credit card reader can include a wireless transceiver that communicates with a remote receiver for accepting or declining the credit transaction.

A coin-operated vending device retrofitted with the kit in accordance with the inventive method has both the note acceptor and the coin acceptor energized by the device's power supply. The coin acceptor generates a first control signal in response to valid input to operate the device by coin, and the note acceptor generates a second control signal in response to valid input to operate the device by note (non-coin payment). The coin acceptor and the note acceptor can operate independently of each other to vend at separate price points for coin or non-coin payment, or can cooperate to vend at a single price point for combination coin and non-coin payment.

Coin-operated vending devices retrofitted for coin and non-coin payment in accordance with the present invention have a number of advantages. Coin operation of the device is unchanged and customers can continue to pay by coin. Existing coin-related components can remain in use, minimizing conversion cost. Customers no longer must pay only by coin, and are more likely to purchase a vend because an alternative payment method is provided. Operators have more flexible pricing options, and price increases can be more easily implemented. Price increases are also more effective because customers will be more likely to make use of the non-coin payment alternative after the increase.

An additional advantage of the present invention is that separate pricing structures can be established for coin payment and non-cash payment. The pricing structure can be made more advantageous for non-coin payment, encouraging its use and enhancing revenue. For example, the price for non-coin payment can be set higher than for coin payment. Yet the customer might receive proportionally more vend time or greater amount of vended product, encouraging the customer to select the higher-price option and thereby increase revenue.

Other objects and features of the present invention will become apparent as the description proceeds, especially when taken in conjunction with the accompanying fifteen drawing sheets illustrating nine embodiments of the invention.

### BRIEF DESCRIPTION OF THE DRAWINGS

FIG. 1 is a view of a prior art coin-operated tire inflator to be retrofitted in accordance with the present invention;

FIG. 2 is a schematic view of components of the tire inflator shown in FIG. 1;

FIG. 3 is a perspective view of a retrofit kit for retrofitting the vending device shown in FIG. 1 for coin and non-coin payment in accordance with the present invention;

FIGS. 4-7 are front, side, rear, and top views respectively of the retrofit kit shown in FIG. 3;

FIG. 8 is a view of the retrofitted vending device created by retrofitting the vending device shown in FIG. 1 with the retrofit kit shown in FIG. 3;

FIG. 9 is a partial sectional view illustrating the attachment of the retrofit kit to the vending device to create the retrofitted vending device shown in FIG. 8;

FIG. 10 is a schematic view of the retrofitted vending device shown in FIG. 8;

FIG. 11 is a perspective view illustrating retrofitting a second coin-operated vending device with the retrofit kit shown in FIG. 3;

FIGS. 12 and 13 are front and rear perspective views respectively illustrating retrofitting a third coin-operated vending device with the retrofit kit shown in FIG. 3, the retrofit kit including a spacer;

FIG. 14 is a perspective view illustrating retrofitting two retrofit kits to a dual-vend coin-operated vending device in accordance with the present invention;

FIG. 15 illustrates an alternative method of mounting the retrofit kits shown in FIG. 14;

FIGS. 16 and 17 are front and side views respectively of a third embodiment retrofit kit in accordance with the present invention, the retrofit kit including a bill acceptor and a credit card reader;

FIG. 18 illustrates operation of the wireless transceiver of the credit card reader shown in FIGS. 16 and 17;

FIG. 19 is a side view of a fourth embodiment retrofit kit for a dual-vend coin-operated vending device in accordance with the present invention;

FIG. 20 is an enlarged view of the area enclosed within the circled area “A” of FIG. 19;

FIG. 21 is a schematic diagram similar to FIG. 10 but illustrating connection of the note acceptor to a multiple-input controller originally provided with vending device 10; and

FIG. 22 is a schematic diagram similar to FIG. 10, the vending device retrofitted with a fifth-embodiment retrofit kit.

### DESCRIPTION OF THE PREFERRED EMBODIMENTS

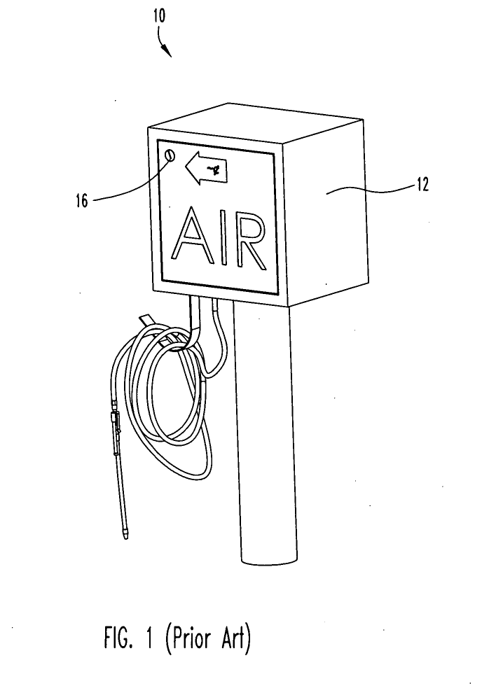

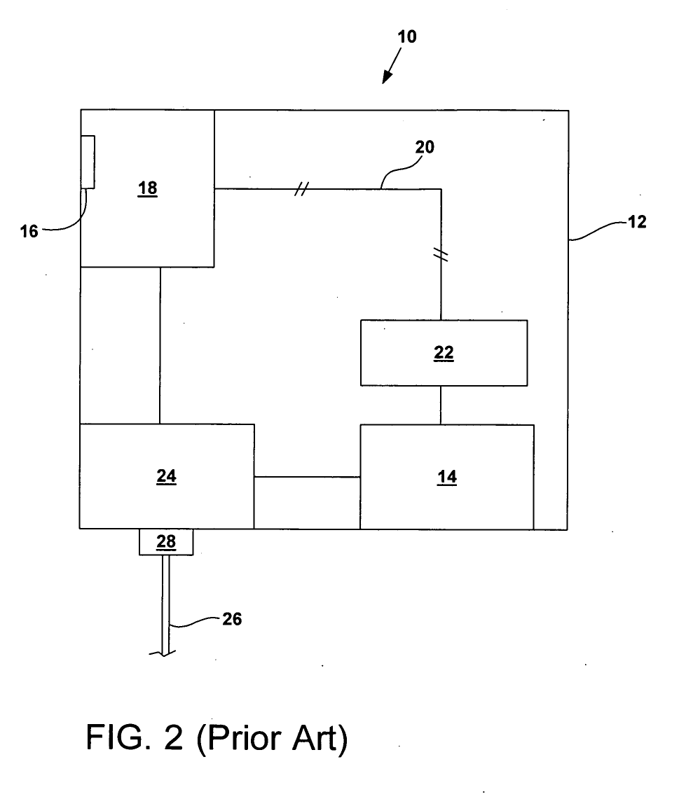

FIGS. 1 and 2 illustrate a conventional coin-operated vending device 10 prior to being retrofitted with a note acceptor in accordance with the present invention. The non-limiting illustrated device 10 is an AIR-SERV AS-7 tire inflator manufactured by AIR-Serv Group, LLC, Mendota Heights, Minn. 55120.

Device 10 has a generally box-shaped outer casing 12 enclosing the operating components of the device. An air pump 14 is actuated when coins are inserted through a coin slot 16 of a coin acceptor 18. The coin acceptor 18 validates the coins and sends a control signal 20 to a controller 22 when at least a minimum value of coins is fed into the slot. Controller 22 actuates the air pump 14 for a defined operating period based on the control signal 20. A power supply 24 supplies power to the coin acceptor 18 an the pump 14. The power supply 24 is connected to an external power source 26 through a junction box 28.

The minimum payment to initiate a vend and the vend cycle time are set in the coin acceptor and controller in a conventional manner. In the illustrated embodiment the tire inflator 10 vends compressed air for 60 seconds upon payment of 75 cents. The coin acceptor 18 validates and accepts 25-cent coins (quarters) and rejects nickels, dimes, pennies, and slugs. A pulse is generated and transmitted as part of the control signal 20 for each quarter validated by the coin acceptor. The controller 22 recognizes three control pulses as a valid control signal 20 and cycles the air pump 14 to vend compressed air for a predetermined time.

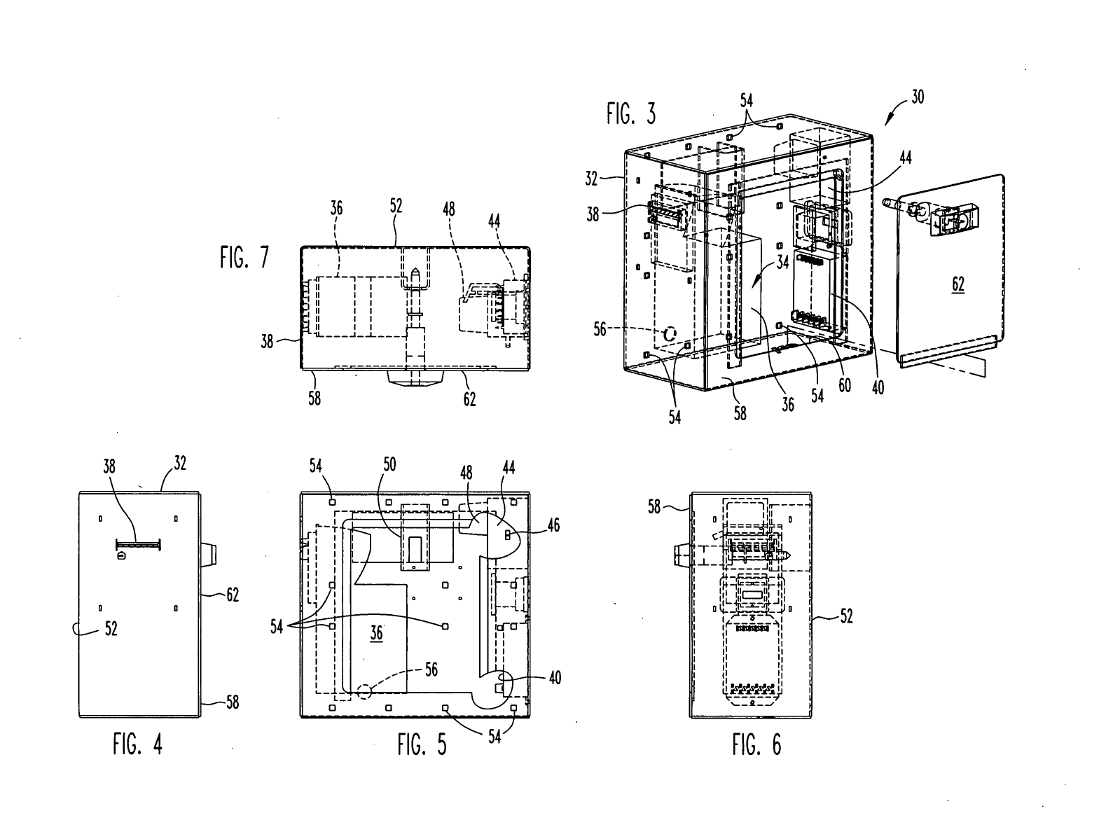

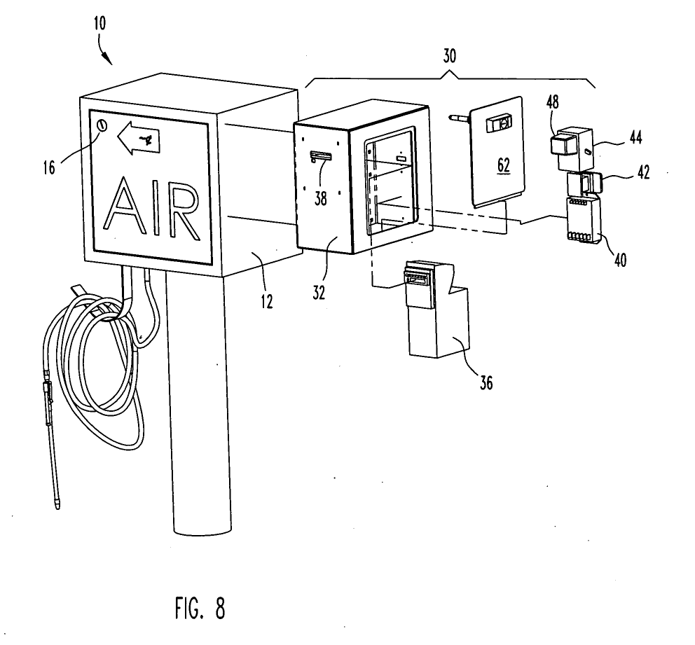

The vending device 10 is coin-operated and accepts only coins for payment. FIGS. 3-7 illustrates a kit 30 for retrofitting the coin-operated device 10 with a note acceptor that enables the device 10 to be operated by non-coin payment such as paper currency, credit card, debit card, ticket, or the like in addition to coin.

Kit 30 includes a box-shaped housing 32 formed from 10-gauge stainless steel plate that mounts a note acceptor 34 and related components inside the housing. The illustrated note acceptor 34 is a bill acceptor that accepts and validates one-dollar bills. The note acceptor 34 includes a bill validator 36 that receives bills through a bill slot 38 formed on the front of the housing 32. The bill acceptor 34 can be a Mars A4 Bill Acceptor manufactured by Mars Electronics International, West Chester, Pa. 19380 or functional equivalent. The bill validator 36 generates a control signal in response to valid input that is sent to a controller 40 that will cycle the air pump 14. A use counter 42 tracks the number of vends initiated by the bill validator 36 to track dollars received. Electrical box 44 receives electrical power into the housing and includes a service switch 46. Transformer 48 and wiring port 50 supply power from the electrical box 44 to the bill validator 36, controller 40, and use counter 42.

The side 52 of the housing 32 is flat and will mount against the outer casing of the device 10. A number of spaced-apart fastener openings or bolt holes 54 and an access hole 56 extend through the side 52. The bolt holes 54 will receive bolts fastening the housing to the outer casing 12. Electrical power and control connections between the electric box 44 and the controller 40 and the device 10 extend through the access hole 56; multiple access holes 56 can be provided if desired. The opposite housing side 58 is also flat and has a cutout 60 that mounts a flush-fit, lockable security door 62 formed from quarter-inch stainless steel plate for service access into the housing.

FIG. 8 illustrates mounting the kit 30 to the side of the device 10. The housing 32 is mounted on a flat surface of the casing 12 without obstructing the front of the device 10 and without interfering with operation of the device 10 as a coin-operated device. The bill slot 38 and the coin slot 16 both face forward, and additional operating instructions and labels can be placed on the front of the housing 32.

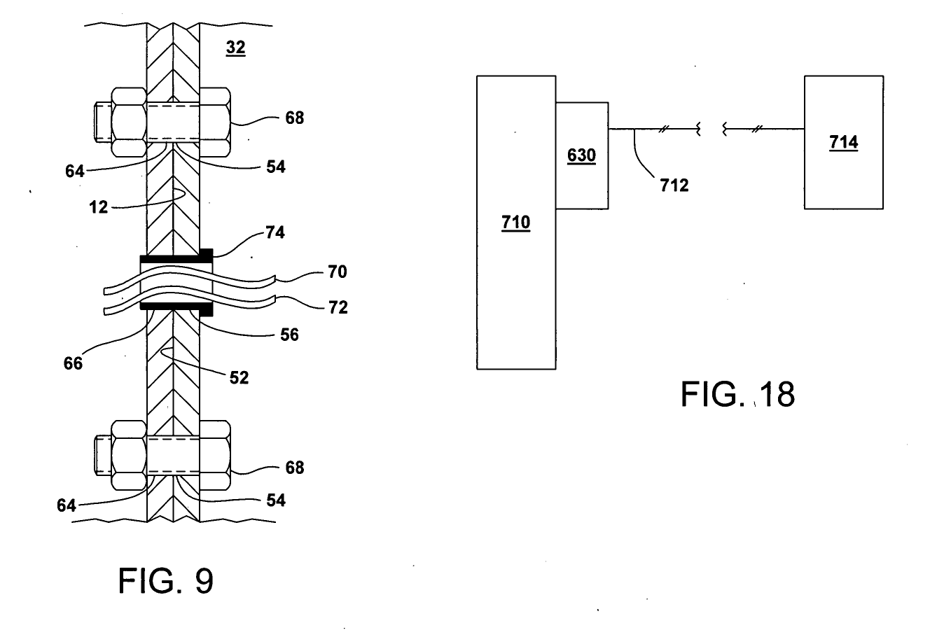

Prior to installing the kit 30, bolt holes 64 and an access hole 66 (see FIG. 9) corresponding to the matching holes 54, 56 are drilled in the housing 12. The hole locations are preferably marked by using a mounting template (not shown) provided with the kit. The device 10 has an access door that provides access to the interior of the housing 12 as needed. Bolts 68 are inserted from the housing 32 and through the holes 64.

The housing surface 52 is tightly mounted against the housing surface by tightening bolts 68. See FIG. 9. In the illustrated embodiment a bolt hole 64 was provided for each corresponding bolt hole 54, but some bolt holes 64 may be omitted if access is limited. The bill acceptor 34, controller 40, and the other kit components are mounted in the housing 32 and wired together as necessary. If desired, these components can be pre-assembled and wired in the housing 32 if the bolts can be reached and tightened. Wiring 70, 72 also passes through the opening defined by access holes 56, 66 and respectively connects the device power supply 24 of the device 10 with the electrical box 44 and the controller 40 with the pump 14. The kit includes a grommet 74 fitted in the access holes to prevent chaffing or cutting of the wires by exposed metal edges.

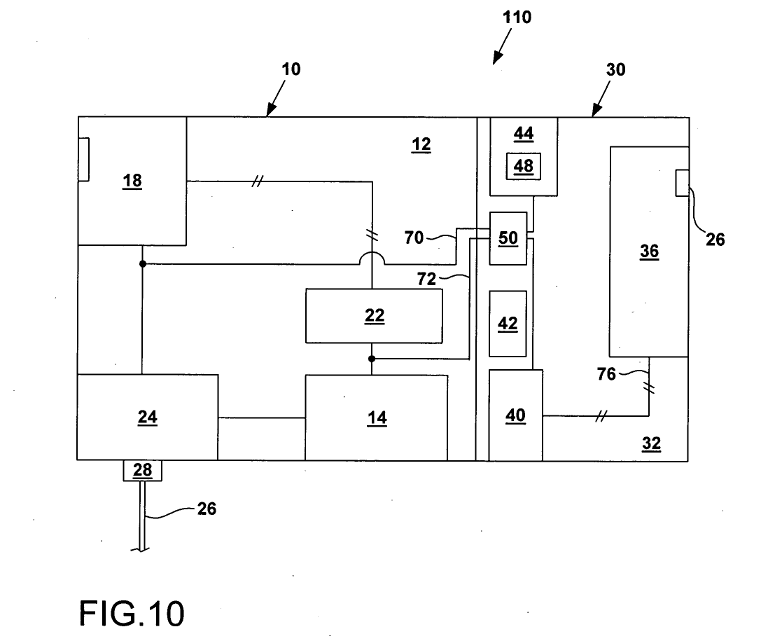

FIG. 10 illustrates the retrofitted coin vending device 110 formed by the device 10 and the retrofit kit 30. The retrofit device 110 independently receives coins or a dollar bill to initiate the vend. Coin operation remains as previously described. For dollar-bill operation, a dollar bill inserted into the currency slot 38 is validated by the bill validator 36. The validator 36 transmits a 4-pulse control signal 76 to the controller 40. The controller 40 recognizes the control signal 76 as a valid control signal and actuates the pump 14 to vend compressed air for 80 seconds.

In the illustrated embodiment the device 10 vends 20 seconds of compressed air for each 25-cents of payment, regardless of whether payment is made by three quarters or by one dollar bill. Controllers 22 and 40 can be independently set, however, and the vend time obtained by paying by dollar bill does not have to be proportional to the vend time obtained by paying three quarters. For example, controller 40 could be set to vend 100 seconds of compressed air to provide additional value that encourages customers to pay by dollar bill.

The bill acceptor 34 does not provide change. In alternative embodiments the bill acceptor could provide change and a coin return slot could be provided in the housing 32. In yet other embodiments the bill acceptor could receive and validate other bills in addition to or instead of one-dollar bills. The bill acceptor can also be adapted for use in other countries and other currencies.

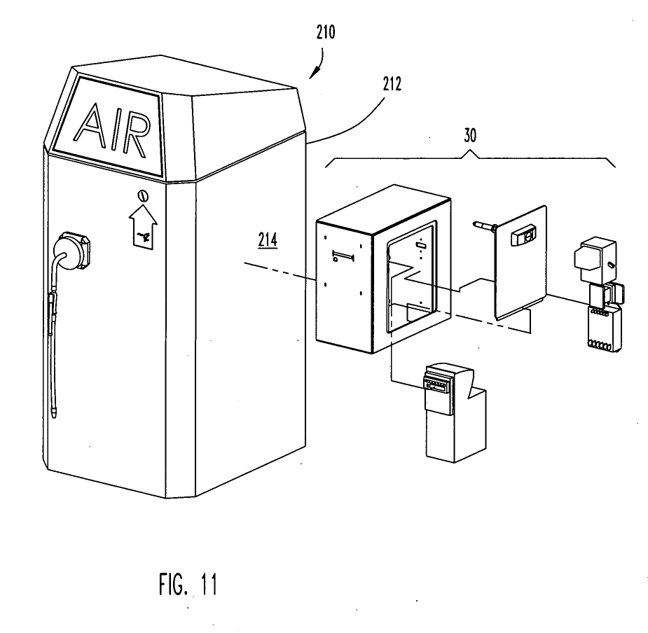

FIG. 11 illustrates the kit 30 being used to retrofit a coin-operated tire inflator 210. The non-limiting illustrated tire inflator 210 is an AIR-SERV AS-8 tire inflator manufactured by AIR-Serv Group, LLC, Mendota Heights, Minnesota 55120. The tire inflator 210 has an outer casing 212 having a flat outer surface 214 that can mount the kit 30. Prior to mounting the kit 30, bolt holes and an access hole (not shown) are formed in the surface 214 as previously described with respect to the tire inflator 10. The kit 30 is then mounted and operatively connected to the tire inflator 210.

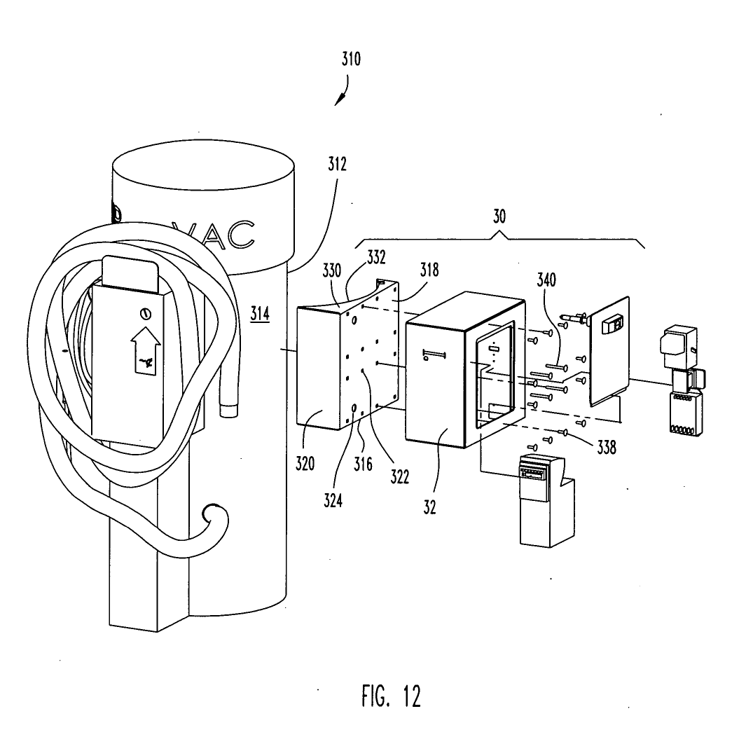

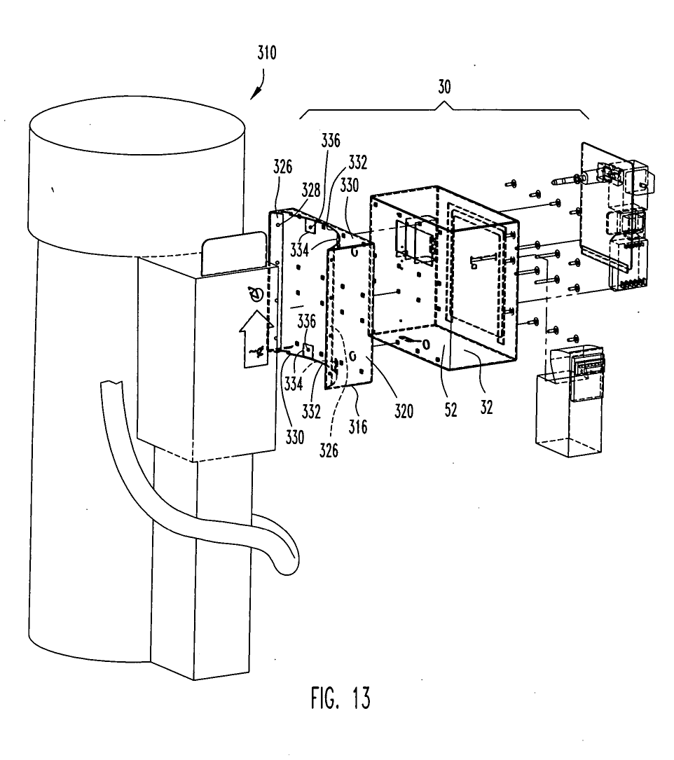

FIGS. 12 and 13 illustrate the kit 30 being used to retrofit a coin-operated vehicle vacuum 310. The non-limiting vacuum 310 is an AIR-SERV VS-7 vacuum manufactured by AIR-Serv Group, LLC, Mendota Heights, Minnesota 55120. The vacuum 310 has a schematic diagram similar to that shown in FIG. 2 for the tire inflator 10, except that the load 14 is a vacuum motor instead of an air pump.

The vacuum 310 has a cylindrical outer casing 312 presenting a curved, non-flat outer surface 314. The casing 312 does not have a sufficiently large, flat surface to mount the housing 32 directly on the casing. Instead, the kit 30 includes a spacer 316 that is configured to be interposed between the casing surface 314 and the housing surface 52. When installed, the spacer 316 tightly abuts the casing surface 314 and spaces the housing 32 away from the casing 312.

The spacer 316 has a “U”-shaped body formed from a flat mounting plate 318 and flat side plates 320. The mounting plate 318 has a number of bolt holes 322 and an access hole 324 extending through the thickness of the plate and in the same pattern as the housing bolt holes 54 and access hole 56. Mounting flanges 326 extend along the outer edges of the plates 320 and extend into the interior of the body. Each flange 326 includes a number of bolt holes 328 spaced along the length of the flange and coaxial with respective bolt holes 322. Like upper and lower plates 330 are attached to the ends of the body. Each plate 330 has a curved outer surface 332 having a radius equal to the radius of the casing surface 314 and inwardly extending mounting flanges 334 with through bolt-hole 336. Each bolt hole 336 is coaxial with a respective bolt hole 322.

Prior to installing the kit 30, bolt holes corresponding to the bolt holes 322 and an access hole corresponding to the access hole 324 are drilled through casing surface 314. It is important to locate the kit 30 in a location that will not interfere with access doors, operating equipment, and the like of the vacuum 310.

To begin the retrofit, the housing 32 is attached to the spacer mounting plate 318 by a number of short bolts 338. Bolts 338 extend through interior bolt holes 322 that are not aligned with bolt holes 328, 336. After the housing 32 is attached to the spacer 316, longer bolts 328 extend through the remaining bolt holes 322, bolt holes 328 and 336, and through the casing bolt holes to mount and mount the spacer/housing assembly onto the device 310. The remaining assembly and operating connections to complete the retrofit are made as previously described.

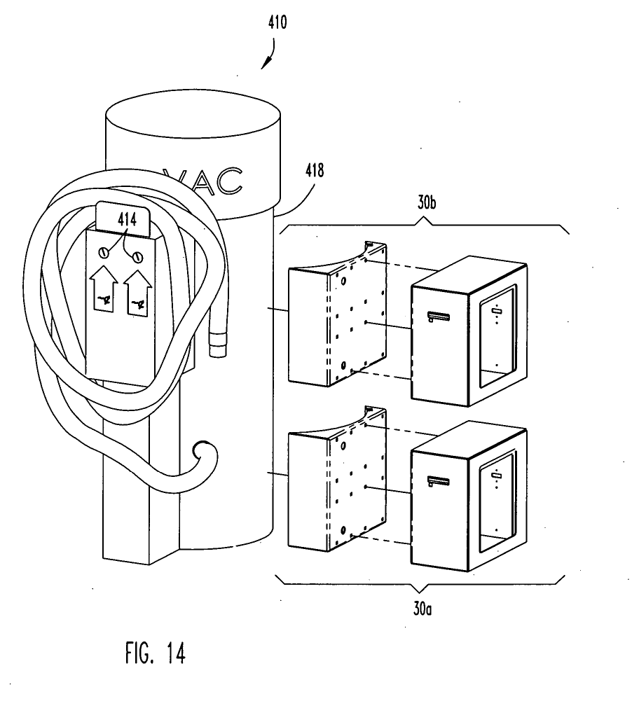

The coin-operated devices 10, 210, and 310 each have a single controller and vend a single service. Multiple retrofit kits 30 can be used to retrofit coin-operated devices having multiple controllers to vend multiple goods or services. FIG. 14 illustrates retrofitting a coin-operated vacuum/air unit 410. The unit 410 may be an AIR-VAC air/vacuum unit manufactured by AIR-Serv Group, LLC, Mendota Heights, Minnesota 55120. The unit 410 independently vends air and vacuum through respective coin slots 414, with separate coin acceptors and controllers for vending each service. This allows the pricing structure of each service to be independently set.

To retrofit unit 410, two like retrofit kits 30a, 30b are installed (some components of the kits are omitted from the drawing for clarity). Each kit 30a, 30b is associated with a respective air or vacuum service and are each attached to the curved outer surface 418. The first kit 30a is operatively connected to the air pump to vend air. The second kit 30b is operatively connected to the vacuum motor to vend vacuum. The pricing structure associated with each kit's controller can be independently set for the appropriate vend service.

There may be multiple locations available to mount a retrofit kit 30. Different locations may require spacers having different conforming surfaces 332, and a given spacer may require plates 330 having differently shaped conforming surfaces or differently-shaped mounting flanges 326 to conform to a given mounting location.

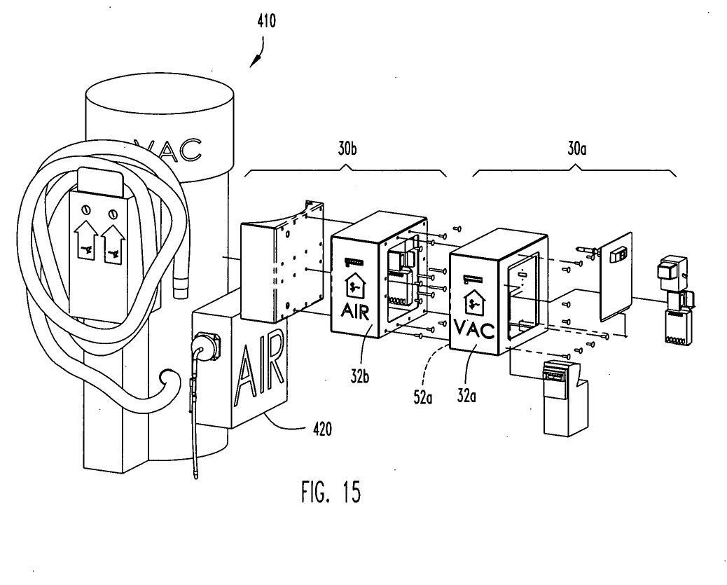

FIG. 15 illustrates an alternative method of mounting the retrofit kits 30a, 30b to the device 410. Retrofit kit 30b is attached as previously described but the door is eliminated. Housing 32a of retrofit kit 30a is mounted directly to the housing 32b. Housing 32b has mounting holes drilled for bolts that mount the housing 32a, and the housing side 52a has an enlarged opening made to enable service access to the interior of the housing 32b. These modifications can be made in the field. Kit 30a is connected and labeled to vend vacuum, and kit 30b is connected and labeled to vend air. By stacking the kits 30a, 30b sufficient area remains on outer surface 418 to mount an air hose retractor 420.

In an alternative embodiment the separate housings 32a, 32b can be eliminated and a single housing sufficiently wide to mount two sets of bill validators, controllers, and use counters is used. Each set is operatively connected to a respective load to additionally enable non-coin payment for each vend.

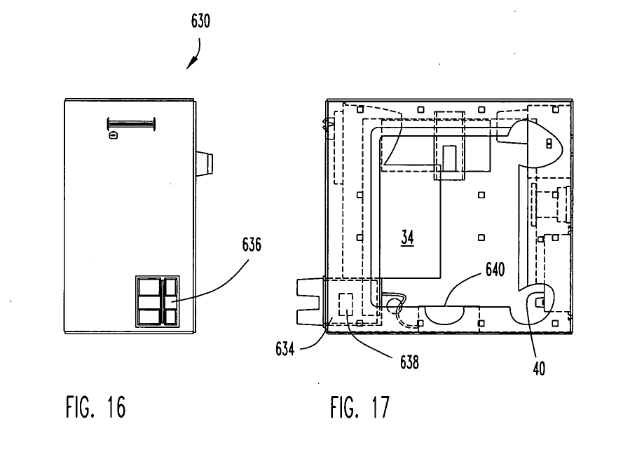

The retrofit kits 30 and 530 described above include note-acceptors that receive and validate dollar-bills only. FIGS. 16 and 17 illustrate a third embodiment retrofit kit 630, similar to the kit 30 with a bill acceptor 34 and controller 40 but additionally including a card acceptor 634 connected to an additional controller 640. The card acceptor 634 accepts credit cards and debit cards via a card slot or swipe reader 636, and includes a wireless transceiver 638 that sends account information to a receiver and receives confirmation to validate card input.

Operation of the transceiver 638 is illustrated in FIG. 18, in which a coin-operated vending device 710 is retrofitted with retrofit kit 630 to enable additional payment by dollar bill or by credit card. When a credit card is inserted in the card acceptor 634, the card acceptor initiates validation of a pre-set charge to the credit card account. The account information is sent by the transceiver 638 via wireless signal 712 to a receiver 714 remote from the device 710. The receiver 714, for example, may be located at an inside cashier station that has facilities to communicate with the credit provider to accept or decline the credit transaction. The credit decision is transmitted via wireless signal back to the transceiver 638 and the vend is either initiated or refused. Preferably all data is transmitted in an encrypted or otherwise secure format.

The kit 630 employs separate controllers 40, 640 to enable the pricing structure of each mode of payment—dollar bill or credit card—to be set independently of the other. Alternatively, the kit 630 can be used as a substitute for the kit 530 for use in multiple-controller coin-operated vending devices. One vending service can be dollar-bill operated, and the other vending service credit-card operated. A multiple-input controller, however, can be used instead of separate controllers.

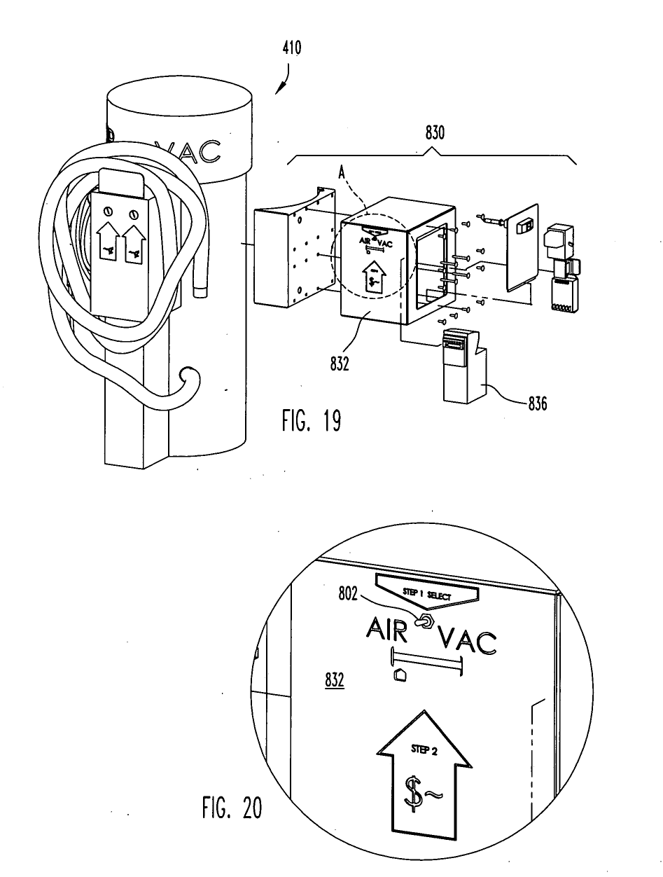

FIGS. 19 and 20 illustrate a fourth embodiment retrofit kit 830 for a dual-vend device such as the previously described air-vacuum device 410. Kit 830 has a single housing 832 that houses a single bill acceptor 836 and two controllers (not shown), each controller associated with a respective vend. A two-position switch 802 mounted on the outside of the housing 832 operatively connects the bill acceptor 836 to the controller associated with the air vend and the controller associated with the vacuum vend. The switch position is set by the customer to select the vend prior to payment.

In other possible embodiment of the present invention, the housing can include two separate note acceptors (for example, a bill acceptor and a credit card acceptor) connected to a single controller. A switch similar to the switch 802 operatively connects the controller with either the bill acceptor or the credit card acceptor. This enables the retrofitted vending device to offer multiple non-coin payment methods to the customer.

The coin-operated devices in the illustrated embodiments operate with a single-input controller. Each retrofit kit has one or controllers that operate independently of the original controller. This enables the price structure associated with non-coin payment to be set independently of the price structure associated with coin payment.

Some coin-operated vending devices, however, may include a multiple-input controller that accepts multiple independent control signal inputs and allow the pricing structure for each input to be individually set. With such devices the retrofit controller can be eliminated for each additional retrofit control signal to be handled by the original controller. The note acceptor generating the additional control signal can be connected directly to the original controller instead of to a controller in the retrofit kit.

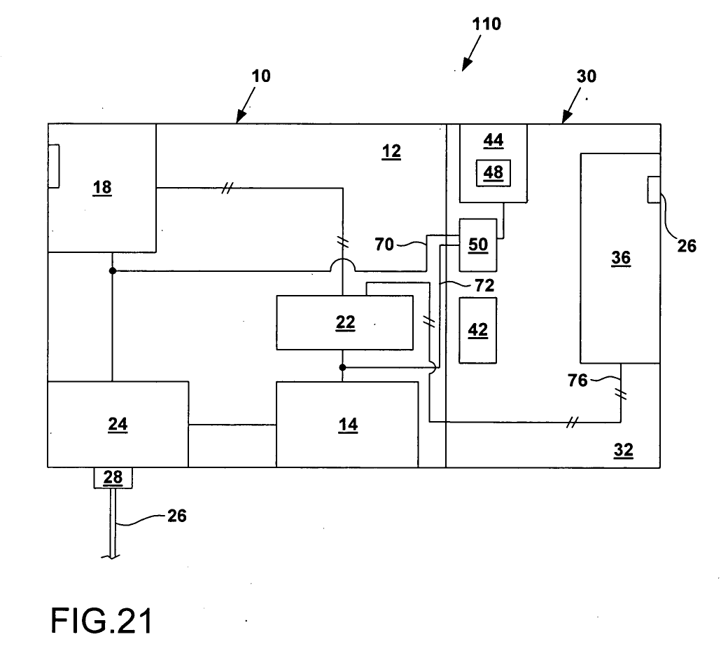

FIG. 21 illustrates the retrofitted vending device 110 in which the vending device 10 is originally equipped with a multiple-input controller 22. The retrofit kit 30 employs a bill validator 36 that generates a control signal 76 compatible with the controller 22. Kit 30 is installed with the signal 76 being sent directly to the controller 22 to control the load 14. The kit controller 40 is not used and can be eliminated.

The controller 22 can control a single vend at a single price point, using the control signals from both the coin acceptor and the bill validator so that payment for the vend can be a combination of coin and bill. Alternatively, the controller 22 can be set up to control the vend at two price points, one price point associated with the coin acceptor and the other price point associated with the bill validator. The length of the vend would be independently set for each price point. The customer would pay by coin only for the one vend associated with the first price point or by bill only for the vend associated with the other price point.

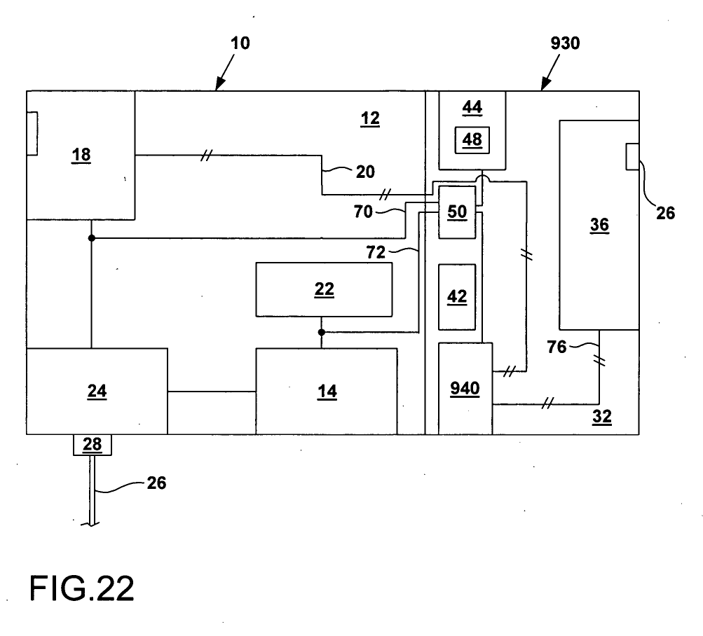

FIG. 22 illustrates retrofitting original vending device 10 with a fifth embodiment retrofit kit 930. The device 10 originally includes a coin acceptor 18 that generates a control signal 20 as previously described. Retrofit kit 930 is similar to retrofit kit 30, except that the kit 930 includes a multiple-input controller 940 rather than a single input controller 40. The control signal 76 generated by the retrofit bill validator 36 is sent to the retrofit controller 940. The control signal 20 is also sent to the retrofit controller 940; the original controller 22 is not used. The retrofit controller 940 can be set to have a single price point payable by a note or coin or combination note and coin, or to have separate price points respectively associated with coin and non-coin payment.

Other note acceptors that can be adapted for use in the present invention include, but are not limited to, ticket readers, debit card readers, thumb-print readers, and other biometric readers or scanners. Different combinations of note acceptors can be used in addition to the dollar-bill and credit card combination illustrated above. The note acceptors can also provide change.

Although the illustrated embodiments include air inflators and vehicle vacuums, it is contemplated that the present invention can be adapted for use with other coin-operated vending devices that vend goods or that vend other services (for example, car washing devices, cleanser dispensers, and the like). Such devices also include coin-operated devices that the operator may selectively permit to be operated for free, perhaps as an incentive for customers to purchase other goods or services (for example, free air for the purchase of six gallons of gasoline).

While I have illustrated and described preferred embodiments of my invention, it is understood that these are capable of modification, and I therefore do not wish to be limited to the precise details set forth, but desire to avail myself of such changes and alterations as fall within the purview of the following claims.

What I claim as my invention is:

1. A method of retrofitting a coin-operated vending device with a note acceptor for receiving paper money, credit cards, tickets, or other types of non-coin payment, the device comprising an outer casing, a coin acceptor in the casing, the coin acceptor generating a first control signal in response to valid input, a power supply to energize the coin acceptor, and a first controller that receives the first control signal to control operation of a load to vend a good or a service, the method comprising the steps of:
(a) mounting a housing on the outer casing outside of the device;
(b) installing a note acceptor in the housing, the note acceptor configured to generate a second control signal in response to valid input to the note acceptor;
(c) connecting the note acceptor to the power supply to energize the note acceptor; and
(d) connecting the note acceptor to one of (A) or (B) to receive the second control signal:
(A) the first controller;
(B) a retrofit controller, the retrofit controller operatively connected to the load in parallel with the first controller whereby each controller is capable of independently controlling the load to vend the good or service;
whereby the device can accept coin or non-coin payment to vend the good or service.

2. The method of claim 1 wherein the note acceptor is a bill acceptor that generates the second control signal upon input of a valid bill.

3. The method of claim 1 wherein step (c) comprises the steps of:
(e) drilling an opening in the housing; and
(f) extending an electrical conductor through the opening to connect the note acceptor to the power supply.

4. The method of claim 1 wherein step (d) comprises the step of connecting the note acceptor to a retrofit controller, the method further comprising the step of:
(e) energizing the retrofit controller from the power supply.

5. The method of claim 1 wherein the vending device is a tire inflation device or vehicle vacuum device.

6. The method of claim 1 wherein step (a) comprises the steps of:
(e) mounting a spacer to the outer casing between the outer casing and the housing; and
(f) attaching the housing to the spacer.

7. The method of claim 6 wherein step (e) comprises the step of:
(g) mounting the spacer to a non-flat surface of the outer casing.

8. The method of claim 1 wherein steps (a)-(d) are performed to retrofit the device with a first note acceptor and further comprising the step of:
(e) repeating steps (a)-(d) to retrofit the device with a second note acceptor.

9. The method of claim 8 wherein the device includes a second load to vend another good or service, a second coin acceptor and a second controller to vend the other good or service, the method further comprising the steps of:
(e) repeating steps (a)-(d) with respect to the second load to retrofit the device with a second note acceptor generating an additional control signal to accept coin or non-coin payment signal to vend the other good or service.

10. The method of claim 9 wherein the housing in step (a) and step (e) is a common housing.

11. The method of claim 1 comprising the step of:
(e) setting a first price for vending the good or service by coin payment; and
(f) setting a second price point for vending the good or service by non-coin payment.

12. The method of claim 1 wherein step (d) comprises the step of connecting the note acceptor to the first controller and the method further comprises the step of:
(e) setting a single price for vending the good or service with payment by any combination of coin and non-coin payment.

13. The method of claim 1 wherein step (d) comprises the step of connecting the note acceptor to a retrofit controller, the method further comprising the step of:
(f) disconnecting the coin acceptor from the first controller and connecting the coin acceptor to the retrofit controller whereby the retrofit controller receives both the first and second control signals.

14. The method of claim 13 further comprising the step of:
(g) setting a single price point for vending the good or service with payment by any combination of coin and non-coin payment.

15. A method of operating a coin-operated vending device retrofitted with a note acceptor whereby the retrofitted device accepts coin or non-coin payment, the note acceptor for receiving paper money, credit cards, tickets, or other type of non-coin payment, the coin vending device before the retrofit comprising a coin acceptor, an original controller connected to the coin acceptor, and a power supply, the note acceptor connected to the original controller or to a retrofit controller, the method comprising the steps of:
(a) energizing both the note acceptor and coin acceptor with the power supply;
(b) transmitting a first control signal from the coin acceptor to one of (A) or (B) in response to a valid input to the coin acceptor:
(A) the original controller, or
(B) the retrofit controller;
(c) transmitting a second control signal from the note acceptor to the controller connected to the note acceptor in response to a valid input to the note acceptor;
wherein steps (b) and (c) are performed independently of each other at different times whereby the device accepts coin or non-coin payment.

16. The method of claim 15 wherein step (c) comprises the step of:
(d) transmitting data between the note acceptor and a data receiver remote from the vending device to validate input to the note acceptor.

17. The method of claim 16 wherein step (d) comprises the step of:
(e) transmitting account data from the note acceptor to the receiver; and
(f) transmitting an accept/decline decision from the receiver to the note acceptor.

18. The method of claim 15 wherein the first control signal is associated with a first price and the second control signal is associated with a second price different from the first price.

19. A kit for retrofitting a coin-operated vending device with a note acceptor so that the device can vend goods or services by either coin or non-coin payment, the vending device comprising an outer surface, a coin acceptor that generates a first control signal in response to valid input, a power supply to energize the coin acceptor, and an original controller that receives the first control signal to actuate a load for vending the goods or services, the kit comprising:
a note acceptor, the note acceptor configured to validate a non-coin payment and generate a second control signal in response to the non-coin payment;
an optional retrofit controller, the retrofit controller configured to be connected to the note acceptor to receive the second control signal and control the load in response to the second control signal;
a housing for housing the note acceptor and retrofit controller, the housing configured for mounting on the outer surface of the device; and
the housing comprising an opening for receiving an electrical connection connecting the note acceptor to the power supply and for connecting the retrofit controller to the load.

20. The kit of claim 19 comprising a spacer for attaching to the outer surface of the device, the housing configured to be attached to the spacer to mount the housing on the device.

21. The kit of claim 20 wherein the spacer has a surface configured to conform to a non-flat outer surface of the device when the spacer is attached to said outer surface.

22. The kit of claim 19 comprising means for attaching the housing to the outer surface.

23. The kit of claim 19 wherein the means for attaching comprises a plurality of openings in the housing arranged in a predetermined pattern.

24. The kit of claim 19 further comprising at least one of the following items: a use counter, a wiring port, an outlet box, and a wireless transceiver.

25. The kit of claim 19 comprising at least one additional note acceptor.

26. The kit of claim 25 wherein the note acceptor is configured for a first type of non-coin payment and the at least one additional note acceptor is configured for a second type of non-coin payment different from the first type.

27. The kit of claim 19 including the optional retrofit collector, the retrofit collector configured to be additionally connected to the coin acceptor to receive the first control signal.
